(19) United States
(12) Patent Application Publication
(10) Pub. No.: US 2026/0001288 A1
(43) Pub. Date: Jan. 1, 2026

(54) COMPOSITE PANEL HOLDER

(71) Applicants: The University of Southern Mississippi, Hattiesburg, MS (US); The Government of the United States, as represented by the Secretary of the Army, Washington, DC (US)

(72) Inventors: Jeffrey Wiggins, Hattiesburg, MS (US); James Rawlins, Hattiesburg, MS (US); Richard Ferguson, Hattiesburg, MS (US); Olivia McNair, Petal, MS (US); John Kent Newman, Vicksburg, MS (US); Todd S. Rushing, Tokyo (JP); Catherine S. Stephens, London (GB); Genevieve Pezzola, Vicksburg, MS (US); Hayden Hanna, Vicksburg, MS (US); Travis Thornell, Vicksburg, MS (US)

(73) Assignees: The University of Southern Mississippi, Hattiesburg, MS (US); The Government of the United States, as represented by the Secretary of the Army, Washington, DC (US)

(21) Appl. No.: 19/249,760

(22) Filed: Jun. 25, 2025

Related U.S. Application Data
(60) Provisional application No. 63/665,730, filed on Jun. 28, 2024.

(51) Int. Cl. B29C 70/42; B29C 70/08; B29K 105/10; B29K 221/00

(52) U.S. Cl. CPC B29C 70/42; B29C 70/08; B29K 2105/101; B29K 2221/00

(57) ABSTRACT

A composite panel holder having a plurality of layers, wherein each layer is a fiber matrix tape including a plurality of fibers immobilized in a matrix of a thermoplastic or thermoset polymer, and each layer is oriented at a different angle but in a same plane relative to a layer it is in direct contact with; and wherein the composite panel holder comprises six portions oriented in different directions, as viewed along a longitudinal axis of the panel holder. A method of preparing the composite panel holder that includes impregnating a plurality of fibers in a thermoplastic or thermoset polymer to form a matrix of fibers in the polymer, forming the matrix into a plurality of unidirectional tapes, stacking the tapes to form a composite structural panel with each of the tapes oriented in a different direction from adjacent tapes; and pressing the structural panel with a thermoforming press.

### STATEMENT OF GOVERNMENT INTEREST

This invention was made with government support under grant nos. 8006508 and 8006811 awarded by the U.S. Army Engineer Research and Development Center (ERDC). The Government has certain rights in the invention.

### BACKGROUND OF THE INVENTION

The breadth and complexity of warfighter force protection for urban environments around the globe requires advancement of lightweight and high strength next-generation force protection materials technology to ensure U.S. Military superiority. Polymer matrix composites continue to rapidly realize broad insertion and adoption within military applications due to their low-cost, design flexibility, light weight, fatigue and corrosion resistance, high performance, extensive supply base, low-cost manufacturing options, and ability to simultaneously integrate multiple functionalities within a structural material which can be used to customize performance.

The existing “Z-bar”, which is a hangar assembly used to connect modular protective systems is fabricated from welded steel and can weigh up to 20 lbs. per Z-bar. These Z-bars are comprised of a welded steel bar including four 90° turns to form a Z shaped bar including a welded fastener. See FIG. 1 (Prior art). Although these Z-bars are well-suited for fabrication using a thermoforming process, the existing Z-bars are costly, heavy and experience permanent deformation and failure upon repetitive impact.

Accordingly, there is a need for a lighter weight and more durable Z-bar or composite panel holder made from a material that can undergo repetitive impacts and sustain an equivalent load to existing welded steel Z-bars.

### SUMMARY OF THE INVENTION

The following sentences may be used to describe the invention.
1. In a first aspect, the present invention relates to a composite panel holder including a plurality of layers, wherein each layer is a fiber matrix tape including a plurality of fibers immobilized in a matrix of a thermoplastic or thermoset polymer, and each layer is oriented at a different angle but in a same plane relative to a layer that it is directly in contact with; and wherein the composite panel holder comprises six portions oriented in different directions, as viewed along a longitudinal axis of the Z-bar.
2. The composite panel holder of sentence 1, wherein the fiber matrix tape may be a unidirectional tape or a woven prepreg tape.
3. The composite panel holder of any one of sentences 1-2, wherein the fibers may be selected from the group consisting of carbon fibers, graphite fibers, glass fibers, ceramic fibers, synthetic polymer fibers, polyimide fibers, high modulus polyethylene (PE) fibers, polyester fibers and polybenzoxazole fibers, aramid fibers, boron fibers, basalt fibers, quartz fibers, alumina fibers, zirconia fibers, aramid, carbon fiber, e-glass, basalt, and combinations thereof.
4. The composite panel holder of any one of sentences 1-3, wherein the thermoplastic or thermoset polymer is selected from the group consisting of epoxy amine, vinyl ester, polyolefins (for example, polyethylene, polypropylene) polyamides, sulfides, ketones, polyether ether ketone, polyethylene terephthalate glycol modified, polyphenylene sulfide, and combinations thereof.
5. The composite panel holder of any one of sentences 1-4, wherein each layer is oriented at an angle of from about-90° to 90°, with respect to an adjacent layer in direct contact therewith.
6. The composite panel holder of any one of sentences 1-5, wherein the one or more fibers are present in an amount of from 50 wt. % to about 75 wt. %, based on a total weight of the composite panel holder.
7. The composite panel holder of any one of sentences 1-6, wherein the thermoplastic or thermoset polymer is present in an amount of from 25 wt. % to about 50 wt. %, based on a total weight of the composite panel holder.
8. The composite panel holder of any one of sentences 1-7, wherein the composite panel holder comprises 10 to 32 layers, or from about 12 to 28 layers.
9. The composite panel holder of claim any one of sentences 1-8, wherein the composite panel holder comprises:
   a first portion;
   a second portion extending at a first obtuse angle from the first portion;
   a third portion extending at a second obtuse angle from the second portion;
   a fourth portion extending at a third obtuse angle from the third portion and parallel to the second portion;
   a fifth portion extending at a fourth obtuse angle from the fourth portion; and
   a sixth portion extending at a fifth obtuse angle from the fifth portion and parallel to the second and fourth portions.
10. The composite panel holder of sentence 9, wherein each of the obtuse angles is 92 degrees.
11. In a second aspect, the present invention relates to a method of preparing the composite panel holder of any one of sentences 1-10, comprising:
   dispersing a thermoplastic or thermoset polymer matrix into a plurality of slurries;
   providing a melt of the thermoplastic or a flow of the thermoset polymer;
   impregnating a plurality of fibers in the thermoplastic or thermoset polymer to form a matrix of fibers in the thermoplastic or thermoset polymer;
   forming the matrix into a plurality of fiber matrix tapes;
   stacking and thermally consolidating the plurality of fiber matrix tapes to form a composite structural panel wherein each of the tapes is oriented in a different direction from each directly adjacent ones of the tapes; and
   pressing the structural panel with a thermoforming press to form the six sized composite panel holder.

Additional details and advantages of the disclosure will be set forth in part in the description which follows, and/or may be learned by practice of the disclosure. The details and advantages of the disclosure may be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIG. 1 shows a metal Z-bar of the prior art.

FIG. 2 shows an example of a thermoplastic composite Z-bar of the present invention.

FIG. 3 shows a chart of the composites employed in the present invention comparing their strength vs tensile modulus. As a reference, the tensile strength of steel is about 1,000 MPa (1 GPa).

FIG. 4 shows a chart of the tensile strength per lb of fiber for a variety of composites.

FIG. 5 shows the mechanical properties of thermoformed carbon fiber compositions with PPS matrix from an open hole compression test according to ASTM D6484. T700 is a Toray T700 carbon fiber, IM7 is Hextow IM7 carbon fiber, ZT50Ks is Zoltek PX35 50k tow carbon fiber, and IMS65s is a Teijin IMS65 carbon fiber.

FIG. 6 shows the mechanical properties of thermoformed carbon fiber compositions with PPS matrix from a force short beam shear test, according to ASTM D2344. T700 is a Toray T700 carbon fiber, IM7 is Hextow IM7 carbon fiber, ZT50Ks is Zoltek PX35 50k tow carbon fiber, and IMS65s is a Teijin IMS65 carbon fiber.

FIG. 7 shows an image of the Z-Bar composite from above, including ply orientations variables. and a chart showing the possible combinations of ply orientations.

FIG. 8 shows a graph of the mechanical properties results versus ply orientation for PA 6 on E-glass 24 ply panels during a short beam shear test.

FIG. 9 shows a graph of the mechanical properties results versus ply orientation for PA 6 on E-glass 24 ply panels during an un-notched tension test.

FIG. 10 shows suitable thermoplastic polymers for use in the present invention.

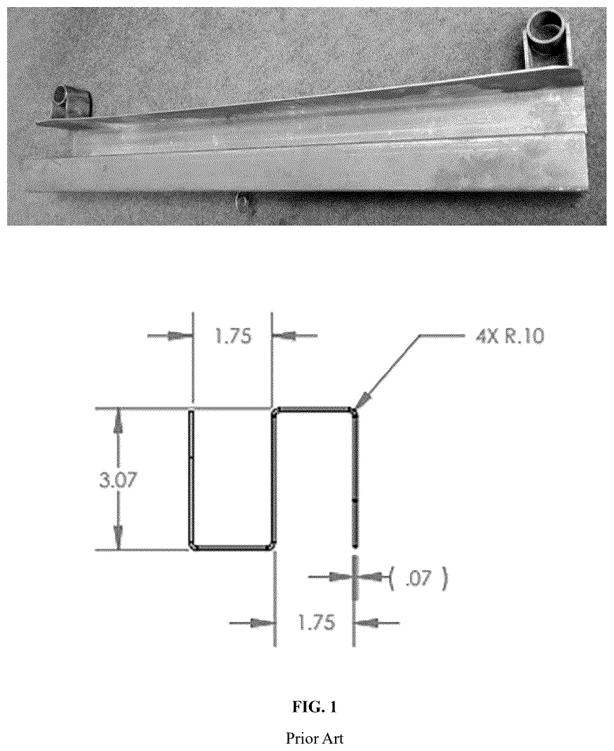

### DETAILED DESCRIPTION OF THE INVENTION

The present invention relates to a composite panel holder that is lighter than a welded steel Z-bar and is resistant to deformation upon repetitive impact, while providing at least the same load capacity of the prior art welded steel Z-bar. In addition, the shape of the composite panel holder of the present invention has been modified as compared to the prior art welded steel Z-bar to incorporate a small angle and add an additional lip to permit stacking and to remove a welding step during fabrication.

In one aspect, the present invention relates to a composite panel holder comprising a pressed composite structural panel having a plurality of layers, wherein each layer is a fiber matrix tape comprising a plurality of fibers and a matrix forming thermoplastic or thermoset polymer. The fiber matrix tape may be unidirectional, woven, or chopped fiber mats. In the composite panel holder of the invention, each layer is oriented at a different angle in a same plane relative to the layer directly in contact therewith. The composite panel holder comprises six portions which can be formed by pressing folds along a longitudinal axis of the composite panel holder.

Each layer of the composite structural panel is formed of unidirectional fiber matrix tape which may be referred to herein as “a ply” or “plies”. The plies are selectively oriented with respect to one another such that each layer of the composite is oriented at a different angle in the same plane relative to the layer directly in contact therewith. The plies may be stacked, manually or automatically, e.g. by automated tape layup using “pick and place” robotics, or advanced fiber placement wherein pre-impregnated tows of fibers are heated and compacted in a mold or a mandrel, to form a composite panel having the desired physical dimensions and layer orientations.

When forming the composite structural panel, the unidirectional fiber matrix tapes are oriented using a specific pattern to ensure a light structure that is resistant to deformation upon repetitive impact. For example, each layer may be oriented at an angle of from −90° to 90°, with respect to a transverse axis of the structural panel. The first and last layer are preferably oriented at an angle of 0° with respect to a transvers axis of the structural panel. The first 50% of layers has the same pattern as the second 50% of layers, except the orientation is mirrored. This provides for a balanced layup. In one embodiment of the present invention, the following pattern may be employed:
Layer 1—0°, Layer 2—90°, Layer 3—0°, Layer 4—90°, Layer 5—0°, Layer 6—90°, Layer 7—0°, Layer 8—90°, Layer 9—90°, Layer 10—0°, Layer 11—90°, Layer 12—0°, Layer 13—90°, Layer 14—0°, Layer 15—90°, Layer 16—0°, and so on, depending on the number of layers therein. In another embodiment of the present invention, the following pattern of orientations may be employed:
Layer 1—0°, Layer 2—−45°, Layer 3—45°, Layer 4—90°, Layer 5—0°, Layer 6—−45°, Layer 7—45°, Layer 8—90°, Layer 9—90°, Layer 10—45°, Layer 11—−45°, Layer 12—0°, Layer 13—90°, Layer 14—45°, Layer 15—−45°, Layer 16—0°, and so on, depending on the number of layers presented therein. In another embodiment of the present invention, the following pattern of orientations may be employed:
Layer 1—0°, Layer 2—60°, Layer 3—−60°, Layer 4—0°, Layer 5—60°, Layer 6—−60°, Layer 7—−60°, Layer 8—60°, Layer 9—0°, Layer 10—−60°, Layer 11—60°, Layer 12—0°.

The composite panel holder of the present invention includes a plurality of layers, preferably, the composite panel holder includes 10 to 32 layers, or from about 12 to 28 layers.

As used herein, the term “composite material” or “composite structural panel” or “composite panel holder” generally refers to an assembly formed from a thermoplastic or thermoset polymer matrix impregnated, coated or laminated onto a plurality of fibers.

The fibers of the composite structural panel may include one or more fibrous materials known in the art to be adapted for the reinforcement of composite structures. The fibers may be organic fibers, inorganic fibers or mixtures thereof. Suitable fibers for use as the reinforcing fiber component include, for example, carbon fibers, graphite fibers, glass fibers, such as E glass fibers, ceramic fibers, such as silicon carbide fibers, synthetic polymer fibers such as aromatic polyamide fibers, polyimide fibers, high-modulus polyethylene fibers, polyester fibers and polybenzoxazole fibers, such as poly-p-phenylene-benzobisoxazole fibers, aramid fibers, boron fibers, basalt fibers, quartz fibers, alumina fibers, zirconia fibers, and mixtures thereof. The fibers may be continuous, discontinuous, woven, chopped fiber mats, and combinations thereof. The fibers may be aligned or randomly oriented.

The fibers of the present invention may provide different benefits. Thus, one type of fiber may be selected over another to achieve certain desired properties, for example, polyolefin glass fiber may be selected if it is desired to have high ductility while foregoing some load bearing capacity. The added benefit is that polyolefins provide a low cost option for composite panels. Alternatively, if load bearing capacity is more important, carbon fiber may be preferred.

More preferably, the fibers may be selected from carbon fibers, glass fibers, synthetic polymer fibers, polyimide fibers, high modulus polyethylene (PE) fibers, polyester fibers and polybenzoxazole fibers, aramid fibers, basalt fibers, and combinations thereof.

The unidirectional or uniaxial fiber tapes of the present invention may be produced by aligning multiple fiber bundles into a tape through a tape line. For example, 12k carbon fiber tow is a fiber bundle comprised of 12,000 individual carbon fibers with diameters between 5 and 7 microns. The beginning of the tape when aligned may expand by about about 60 tows into a tape with a 0.007″ thickness prior to impregnation into the matrix.

The fibers of the composite structural panel may be present in an amount of from 50 wt. % to about 75 wt. %, or from about 55 wt. % to about 65 wt. %, based on the total weight of the composite panel holder. When forming the fiber matrix tape, the fiber may be added to the thermoplastic or thermosetting polymer slurry, i.e. polymer matrix, in an amount of from about 1 wt. % to about 50 wt. %, or from about 1 wt. % to about 25 wt. %, or from about 10 wt. % to about 25 wt. %, based on the total weight of the fiber and the polymer slurry.

The polymer matrix to fiber weight ratio in the final composite structural panel may be equal to the polymer matrix to fiber weight ratio in the fiber matrix tape. The slurry may be prepared with a fine powder polymer matrix, wherein the powder may have an average particle size diameter of from about 5 to 20 microns. The slurry comprising the polymer matrix is dispersed in water using minimal dispersing/stabilization agents. The fiber tows are then pulled through the slurry around rollers which introduce the polymer matrix onto the fibers.

The fiber to slurry ratio may be determined based on 5-6 feet of fiber path length through a 30 or 60 gallon slurry tank. For example, 30 grams to 85 grams of fiber, for a 6″ wide fiber matrix tape, may have from between 145 grams to 300 grams per square meter arial weight, when dipped in a tank between 30 seconds to 5 minutes, depending on line speed.

The matrix forming thermoplastic or thermoset polymer may be prepared by a variety of methods known in the art. The thermoset or thermoplastic polymer may be acquired from any available commercial supplier or may be prepared synthetically using condensation reactions, ring opening reactions, free radical reactions, or other methods well known in the art. Prior to forming a matrix with the one or more fibers, the combination of the thermoplastic or thermoset polymer and the fibers is formed into a slurry. Suitable examples of the thermoplastic or thermoset polymer may be selected from the group consisting of epoxy amine, vinyl ester, polyolefins (for example, polyethylene, polypropylene) polyamides, sulfides, ketones, polyether ether ketone, polyethylene terephthalate glycol modified, polyphenylene sulfide, and combinations thereof. For example, the polyamides may be a polyamide 6 ((C₆H₁₁NO)ₙ), polyamide 12, and polyamide 66.

The thermoplastic or thermoset polymer is present in an amount of from 25 wt. % to about 50 wt. %, or from about 35 wt. % to about 45 wt. %, based on the total weight of the Z-bar. When forming the fiber matrix tape, the thermoplastic or thermoset polymer is formed into a slurry and the one or more fibers are added to form the matrix. The thermoplastic or thermoset polymer may be present in an amount of from about 1 wt. % to about 25 wt. %, or from about 2 wt. % to about 7 wt. %, based on the total weight of the fiber and the polymer slurry.

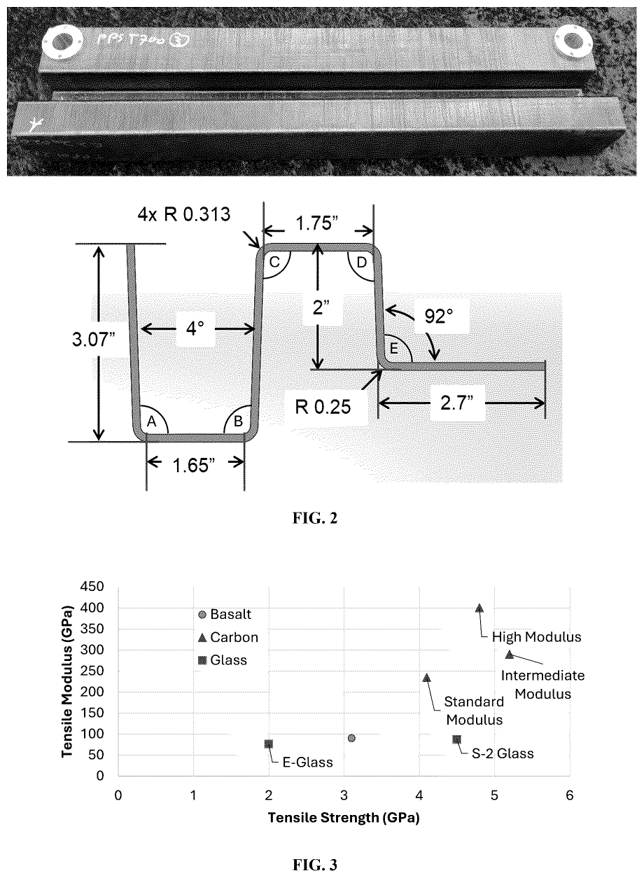

The composite panel holder is formed by pressing the structural panel in a thermoforming process to form a composite panel holder with six portions as shown in the Figures of the present application. Once pressed, the composite panel holder includes a first portion; a second portion extending at a first obtuse angle from the first portion; a third portion extending at a second obtuse angle from the second portion; a fourth portion extending at a third obtuse angle from the third portion and parallel to the second portion; a fifth portion extending at a fourth obtuse angle from the fourth portion; and a sixth portion extending at a fifth obtuse angle from the fifth portion and parallel to the second and fourth portions. FIG. 2 of the drawings shows a suitable embodiment of the present invention.

The composite panel holder of the present invention incorporates five obtuse angles, wherein the obtuse angles range from greater than 90° to about 95°, or from about 91° to about 94°, or about 92°, wherein all five angles can be the same or different, so as to form a composite panel holder having three portions, i.e., the second portion, the fourth portion, and sixth portion that are parallel to one another. The provision of angles greater than 90° to about 95° creates spacing between the first and third portions, and the third and fifth portions that are slightly wider than the lengths of the second, fourth and sixth portions which enables stacking of multiple composite panel holders.

The composite panel holder may also include two openings, one on each end, as shown in FIG. 2, for fastening the composite panel holder. Each opening allows for a variety of fastening mechanisms, for example, friction fit insert, rubber gromets, and multiple variations of threaded fasteners. Optionally, the composite panel holder can be provided with standoffs which may be formed using thermoform tools.

The method for preparing the composite panel holder of the present invention may include steps of:
dispersing a thermoplastic matrix into a plurality of slurries;
providing a melt of a thermoplastic or flow of a thermoset polymer;
impregnating a plurality of fibers in the thermoplastic or thermoset polymer to form a matrix of fibers in the thermoplastic or thermoset polymer;
forming the matrix into a plurality of unidirectional tapes;
stacking and thermally consolidating the plurality of unidirectional tapes to form a composite structural panel wherein each of the tapes is oriented in a different direction from each directly adjacent ones of the tapes; and
pressing the structural panel with a thermoforming press to form the composite panel holder.

Tables 1 and 2 below show the properties of suitable thermoplastic polymer composites that were thermoformed for use in the present invention.

TABLE 1

| | | Water | | Flexibility | Youngs | |
|---|---|---|---|---|---|---|
| | Shrinkage | Absorption | Elongation | (Flexural Modulus) | Modulus | Density |
| | (%) | 24 hours (%) | at Break (%) | (GPa) | (GPa) | (g/cm³) |
| PA 12 | 1.5 | 1.10 | 200 | 1.40 | 1.80 | 1.01 |
| PA 6 | 1.0 | 1.75 | 250 | 1.40 | 1.40 | 1.13 |
| PA 66 | 1.9 | 2.00 | 225 | 1.90 | 2.25 | 1.14 |
| PE | 2.0 | 0.02 | 581 | 1.13 | 1.00 | 0.95 |
| PEEK | 1.3 | 0.30 | 90 | 3.85 | 3.70 | 1.29 |
| PETG | 0.1 | 0.15 | 50 | 2.20 | 1.85 | 1.33 |
| PP | 1.5 | 0.50 | 105 | 1.40 | 1.35 | 0.91 |
| PPS | 1.0 | 0.04 | 25 | 9.42 | 2.86 | 1.35 |

PA 12—(C₁₂H₂₃NO)ₙ—Nylon 12
PA 6—(C₆H₁NO)ₙ—Nylon 6
PA 66—(C₂₂H₂₂N₂O₂)ₙ—Nylon 66
PE—(C₂H₄)ₙ—Polyethylene
PEEK—(C₁₉H₁₂O₃)ₙ—Polyether ether ketone
PETG—H(C₁₀H₈O₄)ₙOH—Polyethylene terephthalate glycol-modified
PP—(C₃H₆)ₙ—Polypropylene
PPS—(C₆H₄S)ₙ—Polyphenylene sulfide

TABLE 2

| | | | Max | Min |
|---|---|---|---|---|
| | Glass | | Continuous | Continuous |
| | Transition | Melt | Service | Service |
| | Temperature | Temperature | Temperature | Temperature |
| | (° C.) | (° C.) | (° C.) | (° C.) |
| PA 12 | 40 | 187 | 70 | −50 |
| PA 6 | 60 | 225 | 100 | −30 |
| PA 66 | 57 | 275 | 110 | −72 |
| PE | 100 | 131 | 97 | −137 |
| PEEK | 143 | 343 | 207 | −68 |
| PETG | 79 | 260 | 63 | −40 |
| PP | −10 | 130 | 80 | −15 |
| PPS | 85 | 281 | 217 | −18 |

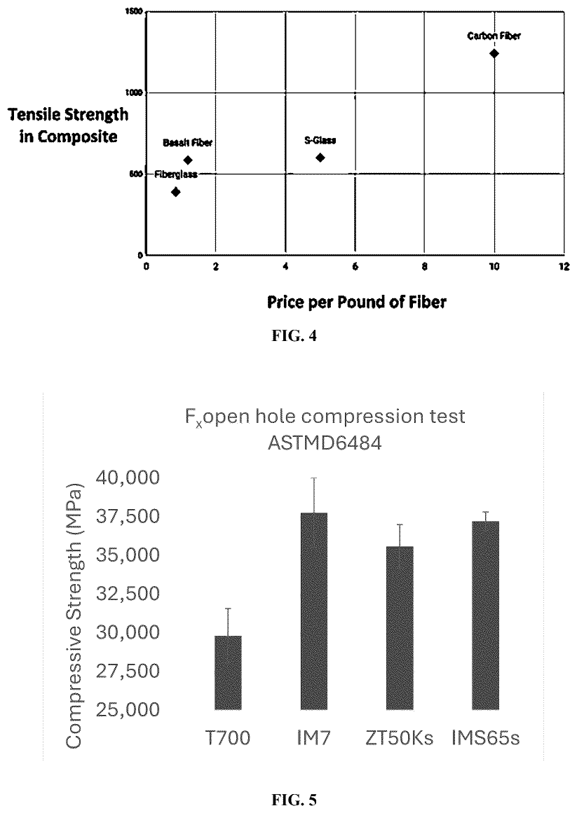

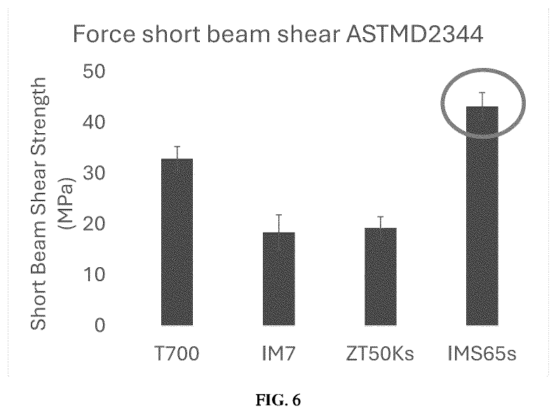

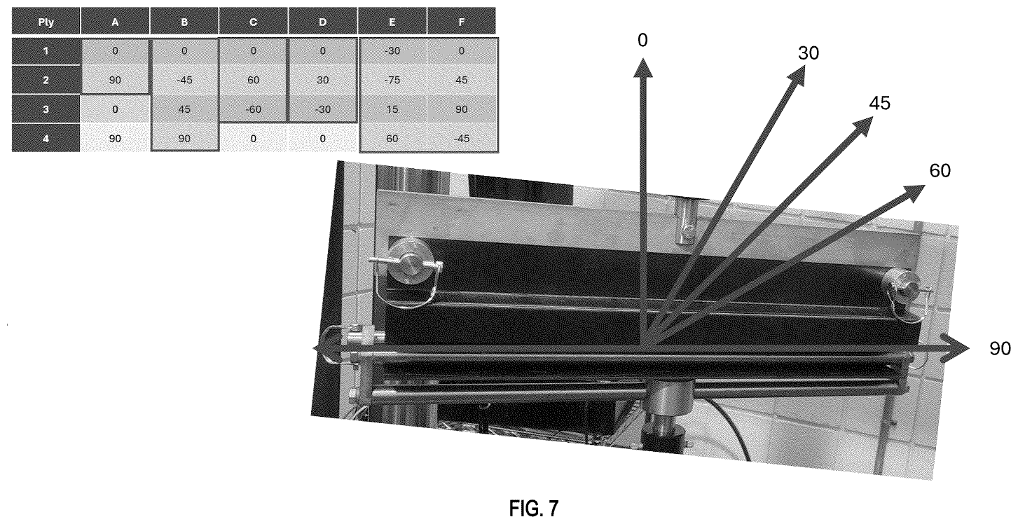

Table 3 and FIGS. 3 and 4 show the properties of suitable fiber materials for use in the present invention.

TABLE 3

| | Tensile | Tensile | Elongation | |
|---|---|---|---|---|
| | Strength | Modulus | at break | Density |
| Type of Fiber | (GPa) | (GPa) | (%) | (g/cm3) |
| Glass | | | | |
| E-Glass | 2.0 | 75.8 | 4.7 | 2.58 |
| S-2 Glass | 4.5 | 86.9 | 5.6 | 2.48 |
| PAN Based Carbon | | | | |
| Standard Modulus | 4.1 | 234.4 | 1.9 | 1.80 |
| Intermediate | 5.2 | 289.6 | 1.7 | 1.80 |
| Modulus | | | | |
| High Modulus | 4.8 | 399.9 | 0.9 | 1.90 |
| Basalt Fiber | 3.1 | 90.0 | 3.5 | 2.63 |

The composite materials of the present invention have an open hole compression strength greater than or equal to 27,500 MPa, or greater than 29,000 MPa, or greater than 30,000 MPa, or greater than 32,000 MPa, or greater than 35,000 MPa, as measured by ASTM D6484.

### EXAMPLES

The following examples are illustrative, but not limiting of the methods and compositions of the present disclosure.

### Example 1

In Example 1, flat 24 ply composites made with a variety of carbon fibers incorporated within a polyphenylene sulfide matrix were tested for their compressive stress and shear strength when fabricated according to the present invention. The plies were oriented in the following patterns:

| Layer | Orientation |
|---|---|
| 1 | 0 |
| 2 | 90 |
| 3 | 0 |
| 4 | 90 |
| 5 | 0 |
| 6 | 90 |
| 7 | 0 |
| 8 | 90 |
| 9 | 0 |
| 10 | 90 |
| 11 | 0 |
| 12 | 90 |
| 13 | 90 |
| 14 | 0 |
| 15 | 90 |
| 16 | 0 |
| 17 | 90 |
| 18 | 0 |
| 19 | 90 |
| 20 | 0 |
| 21 | 90 |
| 22 | 0 |
| 23 | 90 |
| 24 | 0 |

### Open Hole Compression Testing

To test the compressive strength, an open hole compression test according to ASTM D6484 was carried out on composites made with Toray T700 carbon fiber, Hextow IM7 carbon fiber, Zoltek PX35 50k tow carbon fiber, and Teijin IMS65 carbon fiber. The results are shown in FIG. 5. Each of the working examples provided excellent compressive strength as measured in the open hole compression test, of greater than 29,000 MPa, specifically, the working examples demonstrated the following compressive strength values—T700—29,807.0 MPa | IM7—37,763.5 MPa | ZT50Ks—35,586.3 MPa | IMS65s—37,212.2 MPa.

Short beam Shear Testing (SBS)

Short Beam Shearing testing is utilized for material performance comparison under shear like conditions. Short Beam Shearing testing measures interlaminar shear strength (ILSS). The Short Beam Shear test according to ASTM D 2344 placed a specimen (composite panel) onto a horizontal shear test fixture so that the fibers are parallel to the loading nose. The loading nose is then used to flex the specimen at a speed of 0.05 inches per minute until breakage. The force is then recorded. ASTM-2344 specifies a support-span-length-to-specimen-thickness ratio (s/t) of only 4:1. The objective is to minimize the flexural (tensile and compressive) stresses and to maximize the induced shear stress.

ASTM D2344 was followed to obtain short-beam strengths of the four composites described above. The results are shown in FIG. 6. Each of the composites of these working examples provided excellent shear strength of greater than 18 MPa. More specifically, the composites of these examples demonstrated the following short beam shear strength values—T700—32.95 MPa, IM7—18.45 MPa, ZT50Ks—19.29 MPa and IMS65s—43.25 MPa.

### Example 2

In Example 2, a variety of orientation patterns for each of the layers for use in a composite panel according to the present invention were tested for their short beam strength, according to ASTM D2344. Table 4 provides the pattern orientations that were employed for Examples A-F. Examples A-F each included a total of 24 “plies” or layers. Examples A, B, E, and F had a 4 ply pattern, repeated 3 times, then mirrored for an additional 3 times. Examples C and D had a 3 ply pattern, repeated 4 times, then mirrored for an additional 4 times. Table 4 indicates using a bolded line, where the pattern is mirrored between ply 12 and 13. Examples A-F comprised a composite material prepared from E-glass within a polyamide 6 matrix.

TABLE 4

| | Exam- | Exam- | Exam- | Exam- | Exam- | Exam- |
|---|---|---|---|---|---|---|
| Ply | ple A | ple B | ple C | ple D | ple E | ple F |
| 1 | 0 | 0 | 0 | 0 | −30 | 0 |
| 2 | 90 | −45 | 60 | 30 | −75 | 45 |
| 3 | 0 | 45 | −60 | −30 | 15 | 90 |
| 4 | 90 | 90 | 0 | 0 | 60 | −45 |
| 5 | 0 | 0 | 60 | 30 | −30 | 0 |
| 6 | 90 | −45 | −60 | −30 | −75 | 45 |
| 7 | 0 | 45 | 0 | 0 | 15 | 90 |
| 8 | 90 | 90 | 60 | 30 | 60 | −45 |
| 9 | 0 | 0 | −60 | −30 | −30 | 0 |
| 10 | 90 | −45 | 0 | 0 | −75 | 45 |
| 11 | 0 | 45 | 60 | 30 | 15 | 90 |
| 12 | 90 | 90 | −60 | −30 | 60 | −45 |
| 13 | 90 | 90 | −60 | −30 | 60 | −45 |
| 14 | 0 | 45 | 60 | 30 | 15 | 90 |
| 15 | 90 | −45 | 0 | 0 | −75 | 45 |
| 16 | 0 | 0 | −60 | −30 | −30 | 0 |
| 17 | 90 | 90 | 60 | 30 | 60 | −45 |
| 18 | 0 | 45 | 0 | 0 | 15 | 90 |
| 19 | 90 | −45 | −60 | −30 | −75 | 45 |
| 20 | 0 | 0 | 60 | 30 | −30 | 0 |
| 21 | 90 | 90 | 0 | 0 | 60 | −45 |
| 22 | 0 | 45 | −60 | −30 | 15 | 90 |
| 23 | 90 | −45 | 60 | 30 | −75 | 45 |
| 24 | 0 | 0 | 0 | 0 | −30 | 0 |

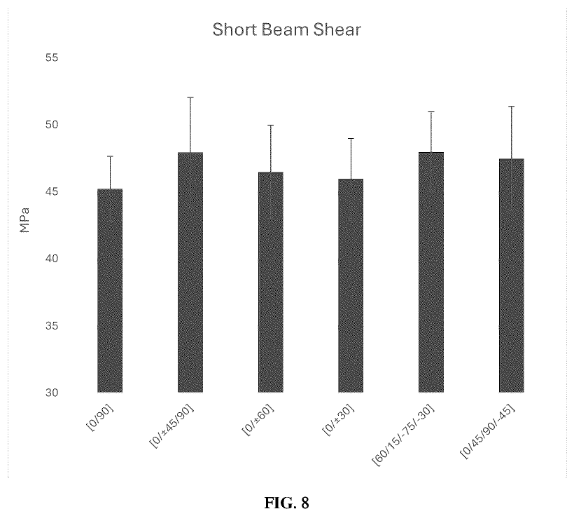

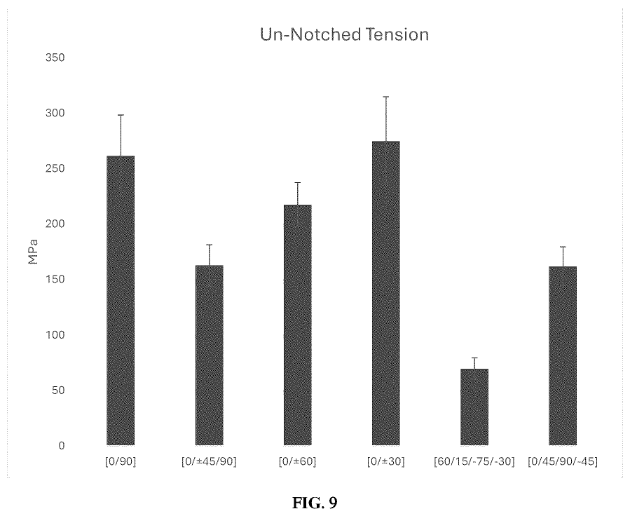

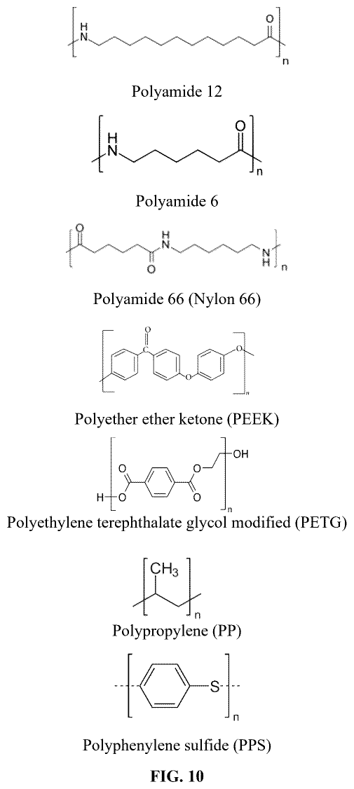

Examples A-F were tested for their short beam strength, according to ASTM D2344. The results are shown in FIG. 8. Each of the composites of the working examples demonstrated excellent shear strength of greater than 45 MPa.

Examples A-F were also tested for unnotched tension via, as determined by ASTM D3039. Examples A and D produced the best results with tensile fatigues of 261.9 MPa and 275.2 MPa, respectively.

### Example 3

A third series of examples were carried out to test prior art metal Z-bars and composite panel holders according to the present invention when subjected to a drop test. Examples 1-25 were prepared with Teijin IMS64 carbon fibers incorporated within a polyphenylene sulfide matrix, configured with an orientation pattern similar to Example A of Example 2, with a variety of fasteners. As shown in Table 5, all Examples were capable of deformation and recovery of their original shape when impacted by lower-energy hits in the drop testing, i.e. less than 1200 J. See Examples 1-4, 9-11, 18-20. However, the composite panel holders according to the present invention were able to withstand multiple-high energy hits, i.e. 2188 J, in the drop testing, whereas the metal Z-bar was only able to sustain a single high energy hit. This is likely due to the fact that the composite panel holders of the present invention deform elastically and, as a result, can recover most if not all of their original shape.

TABLE 5

| | | Drop | Weight of | | Kinetic | | |
|---|---|---|---|---|---|---|---|
| | Fastener | Height | Impactor | Velocity | Energy | Deflection | |
| Example | Type | (ft) | (lb) | (ft/s) | (J) | (in) | Pass/Fail |
| 1 | Rubber | 14 | 26.3 | 31.72 | 557.78 | 1.39 | Pass |
| | Grommet | | | | | | |
| 2 | Rubber | 15 | 26.5 | 32.62 | 594.33 | — | Pass |
| | Grommet | | | | | | |
| 3 | Rubber | 20 | 26.2 | 41.12 | 933.46 | 2.05 | Pass |
| | Grommet | | | | | | |
| 4 | Rubber | 25 | 27.6 | 44.70 | 1162.22 | 2.47 | Pass |
| | Grommet | | | | | | |
| 5 | Rubber | 30 | 26.5 | 50.72 | 1436.81 | 2.80 | Pass |
| | Grommet | | | | | | |
| 6 | Rubber | 14 | 60.3 | 35.06 | 1561.92 | 4.41 | Pass |
| | Grommet | | | | | | |
| 7 | Rubber | 16 | 59.6 | 36.52 | 1675.52 | 4.07 | Fail |
| | Grommet | | | | | | |
| 8 | Rubber | 12 | 60.0 | 32.20 | 1311.47 | 3.67 | Pass |
| | Grommet | | | | | | |
| 9 | Press Fit | 15 | 26.4 | 35.51 | 702.62 | 1.96 | Pass |
| 10 | Press Fit | 20 | 26.4 | 41.99 | 980.99 | 2.62 | Pass |
| 11 | Press Fit | 25 | 26.6 | 46.39 | 1206.13 | 2.07 | Pass |
| 12 | Press Fit | 30 | 26.5 | 52.33 | 1529.49 | 2.41 | Pass |
| 13 | Press Fit | 14 | 60.6 | 33.82 | 1460.61 | 4.49 | Pass |
| 14 | Press Fit | 16 | 60.0 | 37.13 | 1743.75 | 5.53 | Pass |
| 15 | Press Fit | 18 | 60.4 | 37.99 | 1836.66 | 3.80 | Pass |
| 16 | Press Fit | 20 | 60.6 | 40.72 | 2117.95 | 5.23 | Fail |
| 17 | Press Fit | 19 | 61.9 | 40.43 | 2132.51 | 2.46 | Fail |
| 18 | Compression | 15 | 26.3 | 35.21 | 687.22 | 2.38 | Pass |
| | Fit | | | | | | |
| 19 | Compression | 20 | 26.5 | 41.12 | 944.35 | 2.13 | Pass |
| | Fit | | | | | | |
| 20 | Compression | 25 | 26.4 | 46.60 | 1208.14 | 1.17 | Pass |
| | Fit | | | | | | |
| 21 | Compression | 30 | 26.5 | 53.19 | 1580.00 | 2.48 | Pass |
| | Fit | | | | | | |
| 22 | Compression | 16 | 61.4 | 38.01 | 1869.03 | 4.07 | Pass |
| | Fit | | | | | | |
| 23 | Compression | 18 | 61.0 | 40.29 | 2087.15 | 4.28 | Pass |
| | Fit | | | | | | |
| 24 | Compression | 20 | 61.2 | 43.03 | 2388.47 | 3.35 | Fail |
| | Fit | | | | | | |
| 25 | Compression | 19 | 61.1 | 41.15 | 2180.51 | 4.27 | Pass |
| | Fit | | | | | | |
| C1 | Reinforced | 19 | 61.5 | 41.09 | 2188.41 | 1.96 | Pass |
| | Metal | | | | | | |
| C2 | Reinforced | 21 | 60.8 | 44.88 | 2580.72 | 1.94 | Fail |
| | Metal | | | | | | |
| C3 | Reinforced | 21 | 61.8 | 44.39 | 2566.08 | 4.37 | Fail |
| | Metal | | | | | | |

Other embodiments of the present disclosure will be apparent to those skilled in the art from consideration of the specification and practice of the embodiments disclosed herein. As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about,” whether or not the term “about” is present. Accordingly, unless indicated to the contrary, the numerical parameters set forth in the specification and claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. It is intended that the specification and examples be considered as exemplary only, with a true scope and spirit of the disclosure being indicated by the following claims.

The foregoing embodiments are susceptible to considerable variation in practice. Accordingly, the embodiments are not intended to be limited to the specific exemplifications set forth hereinabove. Rather, the foregoing embodiments are within the spirit and scope of the appended claims, including the equivalents thereof available as a matter of law. Other suitable modifications and adaptations of the variety of conditions and parameters normally encountered in the field, and which are obvious to those skilled in the art, are within the scope of the disclosure.

All patents and publications cited herein are fully incorporated by reference herein in their entirety or at least for the portion of their description for which they are specifically cited or relied upon in the present description.

The patentees do not intend to dedicate any disclosed embodiments to the public, and to the extent any disclosed modifications or alterations may not literally fall within the scope of the claims, they are considered to be part hereof under the doctrine of equivalents.

It is to be understood that each component, compound, substituent or parameter disclosed herein is to be interpreted as being disclosed for use alone or in combination with one or more of each and every other component, compound, substituent or parameter disclosed herein.

It is also to be understood that each amount/value or range of amounts/values for each component, compound, substituent or parameter disclosed herein is to be interpreted as also being disclosed in combination with each amount/value or range of amounts/values disclosed for any other component(s), compounds(s), substituent(s) or parameter(s) disclosed herein and that any combination of amounts/values or ranges of amounts/values for two or more component(s), compounds(s), substituent(s) or parameters disclosed herein are thus also disclosed in combination with each other for the purposes of this description.

It is further understood that each range disclosed herein is to be interpreted as a disclosure of each specific value within the disclosed range that has the same number of significant digits. Thus, a range of from 1-4 is to be interpreted as an express disclosure of the values 1, 2, 3 and 4.

It is further understood that each lower limit of each range disclosed herein is to be interpreted as disclosed in combination with each upper limit of each range and each specific value within each range disclosed herein for the same component, compounds, substituent or parameter. Thus, this disclosure to be interpreted as a disclosure of all ranges derived by combining each lower limit of each range with each upper limit of each range or with each specific value within each range, or by combining each upper limit of each range with each specific value within each range.

Furthermore, specific amounts/values of a component, compound, substituent or parameter disclosed in the description or an example is to be interpreted as a disclosure of either a lower or an upper limit of a range and thus can be combined with any other lower or upper limit of a range or specific amount/value for the same component, compound, substituent or parameter disclosed elsewhere in the application to form a range for that component, compound, substituent or parameter.

1. A composite panel holder comprising:
a plurality of layers, wherein each layer is a fiber matrix tape including a plurality of fibers immobilized in a matrix of a thermoplastic or thermoset polymer, and each layer is oriented at a different angle but in a same plane relative to a layer that it is directly in contact with; and
wherein the composite panel holder comprises six portions oriented in different directions, as viewed along a longitudinal axis of the panel holder.

2. The composite panel holder of claim 1, wherein the fiber matrix tape is a unidirectional tape or a woven prepreg tape or the fiber or comprises chopped fiber mats.

3. The composite panel holder of claim 1, wherein the fibers are selected from the group consisting of carbon fibers, graphite fibers, glass fibers, ceramic fibers, synthetic polymer fibers, polyimide fibers, high modulus polyethylene fibers, polyester fibers and polybenzoxazole fibers, aramid fibers, boron fibers, basalt fibers, quartz fibers, alumina fibers, zirconia fibers, aramid, carbon fiber, e-glass, basalt, and combinations thereof.

4. The composite panel holder of claim 1, wherein the thermoplastic or thermoset polymer is selected from the group consisting of epoxy amine, vinyl ester, polyolefins (for example, polyethylene, polypropylene) polyamides, sulfides, ketones, polyether ether ketone, polyethylene terephthalate glycol modified, polyphenylene sulfide, and combinations thereof.

5. The composite panel holder of claim 1, wherein each layer is oriented at an angle of from about −90° to 90°, with respect to an adjacent layer in direct contact therewith.

6. The composite panel holder of claim 1, wherein the one or more fibers are present in an amount of from 50 wt. % to about 75 wt. %, based on a total weight of the composite panel holder.

7. The composite panel holder of claim 1, wherein the thermoplastic or thermoset polymer is present in an amount of from 25 wt. % to about 50 wt. %, based on a total weight of the composite panel holder.

8. The composite panel holder of claim 1, wherein the composite panel holder comprises 10 to 32 layers, or from about 12 to 28 layers.

9. The composite panel holder of claim 1, wherein the composite panel holder comprises:
a first portion;
a second portion extending at a first obtuse angle from the first portion;
a third portion extending at a second obtuse angle from the second portion;
a fourth portion extending at a third obtuse angle from the third portion and parallel to the second portion;
a fifth portion extending at a fourth obtuse angle from the fourth portion; and
a sixth portion extending at a fifth obtuse angle from the fifth portion and parallel to the second and fourth portions.

10. The composite panel holder of claim 9, wherein each of the obtuse angles is 92 degrees.

11. A method of preparing the composite panel holder of claim 1, comprising steps of:
dispersing a thermoplastic or thermoset polymer matrix into a plurality of slurries;
providing a melt of the thermoplastic or a flow of the thermoset polymer;
impregnating a plurality of fibers in the thermoplastic or thermoset polymer to form a matrix of fibers in the thermoplastic or thermoset polymer;
forming the matrix into a plurality of fiber matrix tapes;
stacking and thermally consolidating the plurality of fiber matrix tapes to form a composite structural panel wherein each of the tapes is oriented in a different direction from each directly adjacent ones of the tapes; and
pressing the structural panel with a thermoforming press to form a six portion composite panel holder.

12. A method of preparing the composite panel holder of claim 1, comprising steps of:
impregnating a plurality of fibers in a thermoplastic or a thermoset polymer to form a matrix of the fibers in the thermoplastic or the thermoset polymer;
forming the matrix into a plurality of unidirectional tapes;
stacking the plurality of unidirectional tapes to form a composite structural panel wherein each of the tapes is oriented in a different direction from each directly adjacent one of the tapes; and
pressing the structural panel with a thermoforming press to form the composite panel holder.
